(19) United States
(12) Patent Application Publication
(10) Pub. No.: US 2009/0128754 A1
(43) Pub. Date: May 21, 2009

(54) MANUFACTURING METHOD THEREOF AND LIQUID CRYSTAL DISPLAY PANEL

(75) Inventors: Teruaki SUZUKI, Kawasaki (JP); Sounosuke Takahashi, Kawasaki (JP); Taku Kawasaki, Kawasaki (JP); Shinichi Nishida, Kawasaki (JP); Yoshikazu Sakaguchi, Kawasaki (JP); Hideki Ito, Kawasaki (JP)

Correspondence Address: YOUNG & THOMPSON, 209 Madison Street, Suite 500, ALEXANDRIA, VA, 22314, US

(73) Assignee: NEC LCD TECHNOLOGIES, LTD., Kawasaki (JP)

(21) Appl. No.: 12/264,422

(22) Filed: Nov. 4, 2008

(30) Foreign Application Priority Data
Nov. 15, 2007 (JP) 2007/296732

(51) Int. Cl. G02F 1/1335; G02B 5/20; B29D 11/00

(52) U.S. Cl. 349/106; 359/891; 156/100

(57) ABSTRACT

A color filter substrate includes a display area for displaying images, a frame area being adjacent to the display area and at least two kinds of laminated pieces which are composed by laminating at least two pieces of colored layers each including a different color. Here, the laminated pieces are arranged in the frame area in a shape of mosaic.

### INCORPORATION BY REFERENCE

This application is based upon and claims the benefit of priority from Japanese Patent Application No. JP 2007-296732, filed on Nov. 15, 2007, the disclosure of which is incorporated herein in its entirety by reference.

### BACKGROUND OF THE INVENTION

1. Technical Field

The present invention relates to a color filter substrate, a manufacturing method thereof and a liquid crystal display panel. In particular, the present invention relates to a color filter substrate which adopts a structure of laminating colored layers each having a different color instead of a black matrix as a light blocking structure, a manufacturing method thereof and a liquid crystal display panel which includes the color filter substrate.

2. Background Art

In recent years, a lower cost liquid crystal display apparatus is required. One example of the lower cost liquid crystal display apparatus is that a colored layer is applied as a light blocking layer instead of the black matrix.

A common liquid crystal display apparatus includes a display area in which an image picture is displayed and a frame area in which an image is not displayed and a wiring or the like drawn from the display area is arranged. In the frame area, the light blocking layer such as a black matrix is arranged to cover the wiring and to prevent light from entering the display area 1 from the frame area.

FIG. 15 exemplifies a cross section view of a liquid crystal display apparatus having a black matrix 25 as the light blocking layer and FIG. 16 exemplifies a cross section view of a liquid crystal display apparatus having a Laminated-layer composing of a green (G) colored layer 21, a red (R) colored layer 22 and a blue (B) colored layer 23 in place of the black matrix 25 as the light blocking layer.

In FIG. 15 and FIG. 16, the liquid crystal display apparatus is formed by placing a color filter substrate 20E or 20F opposite an array substrate 30 and by arranging a seal 40 and liquid crystal 50 therebetween. In FIG. 15, the black matrix 25 is arranged in a frame area 2 of a color filter substrate 20E. On the other hand, in FIG. 16, the laminated-layer composing of the colored layers 21, 22 and 23, that is, a laminated-layer is arranged in the frame area 2 of a color filter substrate 20F. Then, light emitted from a backlight is through liquid crystal 50, and is blocked by the black matrix 25 in FIG. 15 or the laminated-layer composing of the colored layers 21, 22 and 23 in FIG. 16.

Here, since the laminated-layer becomes thicker than the black matrix 25, there are problems that the orientation of the liquid crystal 50 may become disordered and it may become obstacle to pour the liquid crystal 50 into the liquid crystal display apparatus.

Accordingly, a related art 1 (Japanese Patent Application Laid-Open No. 1988-183421) discloses that a laminated-layer of dyed resin layers each having a different spectrophotometric characteristics is applied as a light blocking layer and that the dyed resin layers are laminated with each edge of the dyed resin layers shifted step ward.

The related art 2 (Japanese Patent Application Laid-Open No. 2000-29014) discloses a light blocking layer formed by laminating at least two colored resin layers each having a different color in a frame area and discloses that gradient angle of end of the light blocking layer is specified.

The related art 3 (Japanese Patent Application laid-Open No. 2003-14917) discloses a light blocking layer formed by laminating at least two colored resin layers each having a different color and discloses that each transmission factor of colored layers is specified.

The related art 4 (Japanese Patent Application Laid-Open No. 2007-121326) discloses a light blocking layer formed by laminating more than three colored members each having a different color and discloses that the upper the colored member is, the narrower the formed area of the coloring layer is.

The related art 5 (Japanese Patent Application Laid-Open No. 2003-66435) discloses that a first laminated body composing of a B colored layer, a R colored layer and a G colored layer, a second laminated body composing of the B colored layer and the G colored layer and a third body composing of only the B colored layer are arranged by an equal area as a light blocking layer.

### SUMMARY

An exemplary object of the present invention is to provide a color filter substrate, a manufacturing method thereof and a liquid crystal display panel which can reduce thickness of a light blocking layer gradually to avoid unnatural coloring in a peripheral end area of a frame area, and an area adjacent to a display area. Another exemplary object of the present invention is to provide a color filter substrate, a manufacturing method thereof and a liquid crystal display panel which can provide high display quality.

A color filter substrate according to an exemplary object of the invention includes a display area for displaying images, a frame area being adjacent to the display area and at least two kinds of laminated pieces which are composed by laminating at least two pieces of colored layers each including a different color. Here, the laminated pieces are arranged in the frame area in a shape of mosaic.

In a liquid crystal display panel in which liquid crystal is enclosed between an array substrate and a color filter substrate according to an exemplary object of the invention, the color filter substrate includes a display area for displaying images, a frame area being adjacent to the display area and at least two kinds of laminated pieces which are composed by laminating at least two pieces of colored layers each including a different color. Here, the laminated pieces are arranged in the frame area in a shape of mosaic.

A method for manufacturing a color filter substrate including a display area for displaying images and a frame area being adjacent to the display area according to an exemplary object of the invention includes forming a first colored layer on predetermined areas in the display area and the frame area, forming a second colored layer on a part of an area on which the first colored layer is not formed in the display area, a part of an area on which the first colored layer is not formed in the frame area and a part of an area on which the first colored layer is not formed in the frame area, and forming a third colored layer on an area on which the first and second colored layers are not formed in the display area and an area on which the first and second colored layers are not overlapped in the frame area.

A method for manufacturing a color filter substrate including a display area for displaying images and a frame area being adjacent to the display area according to an exemplary object of the invention a, in case that the frame area being adjacent to the display area includes a first area and a second area being adjacent to the first area, includes forming a first colored layer on predetermined areas in the display area and the frame area, forming a second colored layer on a part of an area on which the first colored layer is not formed in the display area, a part of an area on which the first colored layer is not formed in the frame area and a part of an area on which the first colored layer is not formed in the frame area, and forming a third colored layer on an area on which the first and second colored layers are not formed in the display area and an area on which the first and second colored layers are not overlapped in the frame area.

A method for manufacturing a color filter substrate including a display area and a frame area adjacent to the display area according to an exemplary object of the invention includes arranging a first colored layer, a second colored layer and a third colored layer in the display area alternately, and arranging three kinds of laminated pieces composed by laminating two pieces out of a piece of a first colored layer, a piece of a second colored layer and a piece of a third colored layer in the frame area in a shape of mosaic.

### BRIEF DESCRIPTION OF THE DRAWINGS

Exemplary features and advantages of the present invention will become apparent from the following detailed description when taken with the accompanying drawings in which:

FIG. 1A is a top view of a color filter substrate 20A according to a first exemplary embodiment of the present invention;

FIG. 1B is a partially enlarged plan view of an area Z in FIG. 1A;

FIG. 2 is a cross section view of a liquid crystal display panel 10A taken along the line J-J′ in FIG. 1B;

FIG. 3 is a cross section view of the liquid crystal display panel 10A taken along the line K-K′ in FIG. 1B;

FIG. 4 is a cross section view of the liquid crystal display panel 10A taken along the line L-L′ of FIG. 1B;

FIG. 5 is a plan view exemplifying a shape of a G colored layer 21 of the color filter substrate 20A according to the first embodiment of the present invention;

FIG. 6 is a plan view exemplifying a shape of a R colored layer 22 of the color filter substrate 20A according to the first embodiment of the present invention;

FIG. 7 is a plan view exemplifying a shape of a B colored layer 23 of the color filter substrate 20A according to the first embodiment of the present invention;

FIG. 8 is a plan view of a color filter substrate 20B according to a second exemplary embodiment of the present invention;

FIG. 9A is a partially enlarged view of an area X shown in FIG. 8;

FIG. 9B is a partially enlarged view of an area Y shown in FIG. 8;

FIG. 10 is a plan view of a color filter substrate 20C according to a third exemplary embodiment of the present invention;

FIG. 11A is a partially enlarged view of an area X shown in FIG. 10;

FIG. 11B is a partially enlarged view of an area Y shown in FIG. 10;

FIG. 12 is a partially enlarged view of an area Z shown in FIG. 10;

FIG. 13 is a plan view of a color filter substrate 20D according to a fourth exemplary embodiment of the present invention;

FIG. 14 is a partially enlarged view of an area W shown in FIG. 13;

FIG. 15 is a cross section view of an area near to a frame area of a liquid crystal display apparatus having the black matrix according to a related art; and

FIG. 16 is a cross section view of an area near to a frame area of a liquid crystal display apparatus to which the black matrix is not applied according to a related art.

### EXEMPLARY EMBODIMENT

Exemplary embodiments of the present invention will now be described in detail in accordance with the accompanying drawings.

### A First Exemplary Embodiment

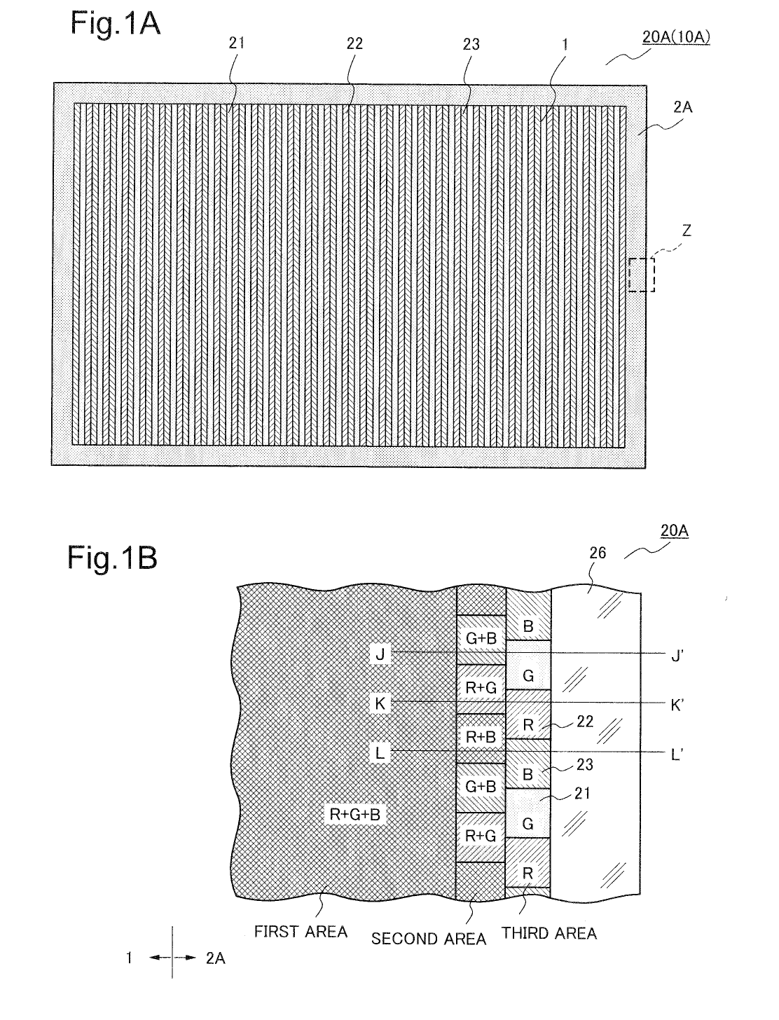

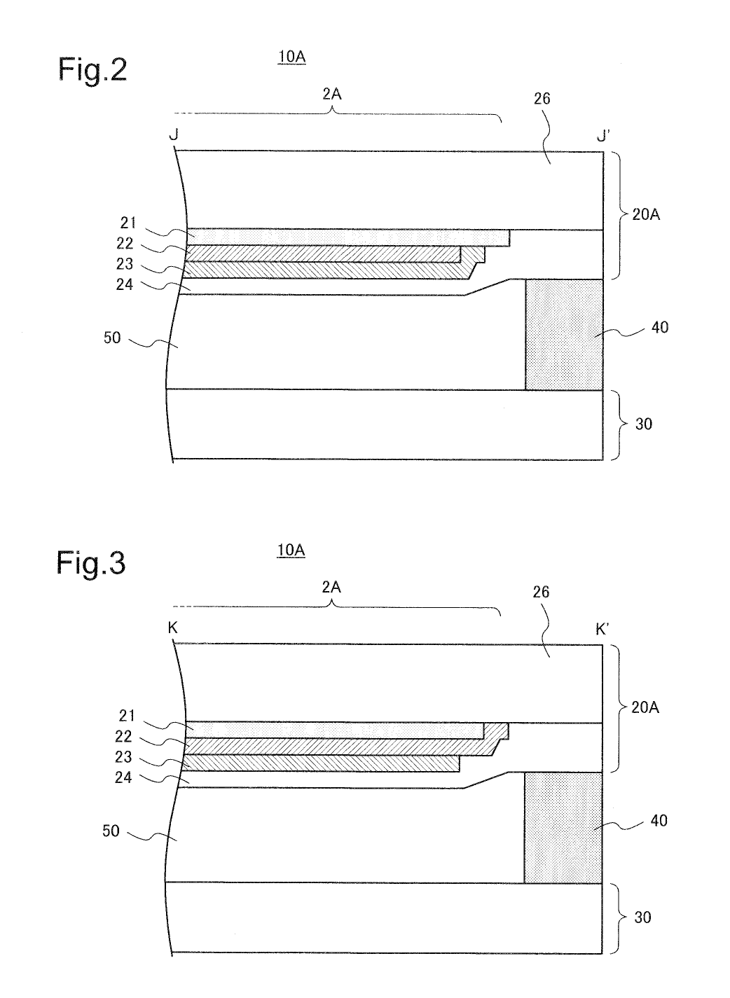

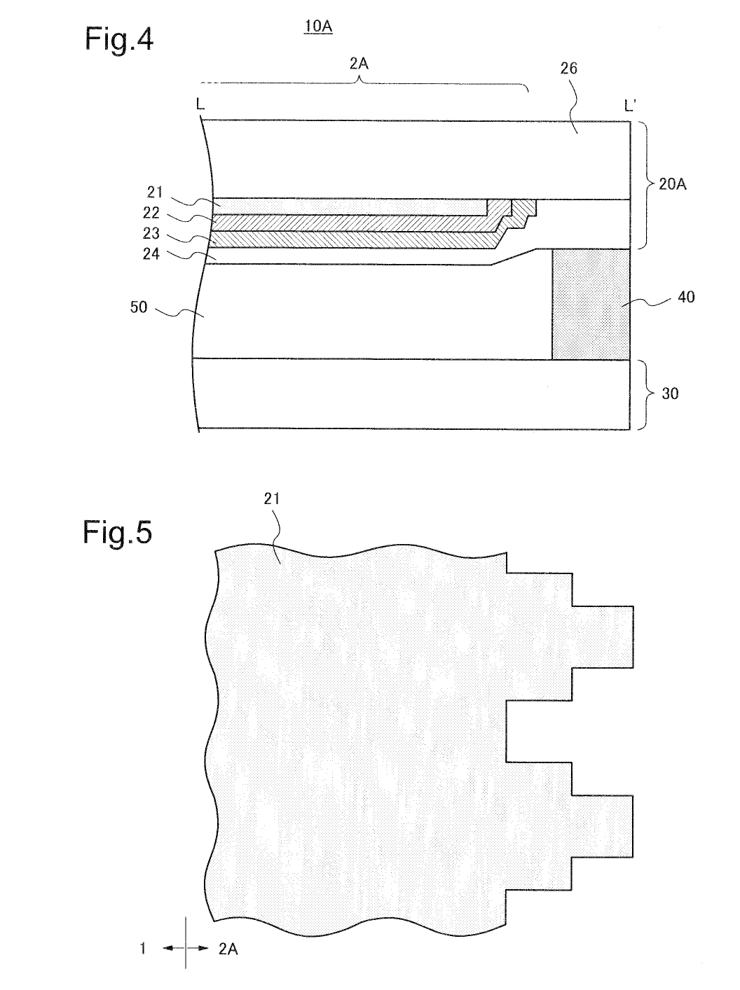

A color filter substrate and a liquid crystal display panel according to a first exemplary embodiment of the present invention will be described in the following. FIG. 1A is a top view of a color filter substrate 20A according to the first embodiment and FIG. 1B is a partially enlarged plan view of an area Z shown in FIG. 1A. FIGS. 2 to 4 are cross section views of the liquid crystal display panel 10A taken along lines J-J′, K-K′ and L-L′ shown in FIG. 1B respectively. FIGS. 5 to 7 are plan views of a green (G) colored layer 21, a red (R) colored layer 22 and a blue (B) colored layer 23 which work as a color filter of the color filter substrate 20A respectively. In following figures, each of the colored layers 21, 22 and 23 is identified by kind of hatching. That is, dot denotes the G colored layer 21, a diagonal line in upper right direction denotes the R colored layer 22 and a diagonal line in lower right direction denotes the B colored layer 23.

As shown in FIGS. 2 to 4, the liquid crystal display panel 10A according to the first embodiment includes an array substrate 30, the color filter substrate 20A which is opposite to the array substrate 30, liquid crystal 50 which is interposed between the color filter substrate 20A and the array substrate 30, and a seal 40 which joins two substrates together and seals the liquid crystal 50 therebetween.

The array substrate 30 includes a pixel (not shown in Figure) having a switching element such as TFT (Thin Film Transistor). According to the first embodiment, each pixel is arranged in shape of matrix in a display area of the array substrate 30. A wiring (not shown in Figure) connected to each switching element or the like is drawn in a frame area which is arranged outside of the display area of the array substrate 30.

Meanwhile, the color filter substrate 20A includes a glass substrate 26 made of a glass and the colored layers 21, 22 and 23 arranged on the glass substrate 26. As shown in FIG. 1A, the colored layers 21, 22 and 23 are arranged in shape of stripe in the display area 1 alternately, and the frame area 2A is arranged outside of the display area 1. As shown in FIGS. 2 to 4, the colored layers 21, 22 and 23 are laminated and arranged on the glass substrate 26 in the frame area 2A instead of a black matrix, and the laminated colored layers 21, 22 and 23 are coated with an overcoat layer 24.

The frame area 2A of the color filter substrate 20A will be described in detail with FIG. 1B. In a main area (a first area) which occupies most the frame area 2A of the color filter substrate 20A and is formed of a four sided figure, a laminated body composed of at least two of the colored layers each having a different color is arranged on the glass substrate 26. In the first embodiment, a laminated-three-layers body composed of the G colored layer 21, the R colored layer 22 and the B colored layer 23 is arranged in the first area, and the first area is formed in a laminated-three-layers structure. The laminated body has a high light blocking effect, so the laminated body can replace the black matrix enough.

As shown in FIG. 1B, in a second area which is adjacent to outside of the first area, a plurality of at least two kinds of laminated pieces by laminating at least two pieces of the colored layers each having a different color are arranged on the glass substrate 26 in a shape of mosaic. In the first embodiment, some laminated pieces composed of a piece of the G colored layer 21 and a piece of the R colored layer 22, some laminated pieces composed of a piece of the G colored layer 21 and a piece of the B colored layer 23 and some laminated pieces composed of a piece of the R colored layer 22 and a piece of the B colored layer 23 are arranged in the second area in a shape of mosaic. That is, several kinds of laminated-two-layers pieces are arranged in the second area in a shape of mosaic, and the second area is formed in a mosaic-shape laminated-two-layers structure.

Moreover, in a third area which is adjacent to outside of the second area, some pieces of the G colored layer 21, some pieces of the R colored layer 22 and some pieces of the B color layer 23 are arranged in shape of mosaic alternately. Then, the third area is formed in a mosaic-shape one-layer structure.

The frame area 2A of the color filter substrate 20A includes the first area which is formed in the laminated-three-layers structure, the second area which is formed in the mosaic-shape laminated-two-layers structure and the third area which is formed in the mosaic-shape one-layer structure. Therefore, in the frame area 2A of the color filter substrate 20A, number of colored layers for laminating decreases gradually toward the peripheral end of the color filter substrate 20A and total thickness thereof decreases stepwise. Accordingly, the liquid crystal 50 can be poured easily between the substrates and avoid the disorder of the orientation.

Moreover, since several kinds of the laminated-plural-layers or one-layer pieces are arranged in shape of mosaic in the area in which number of the colored layers for laminating decrease, the pieces can be made ineffective in coloring macroscopically mutually (achromatic). Accordingly, it is possible to avoid unnatural coloring, and it is possible consequently to provide the color filter substrate with high display quality without achromaticity.

In the first embodiment, the pieces of the colored layers 21, 22 and 23 composing the laminated-plural-layers or one-layer pieces are designed to be the same size. The size of piece is arbitrary, but the size may be formed minutely preferably so that the pieces can be made ineffective mutually in coloring macroscopically. For example, it is preferable that the size of the piece is formed as large as that of pixel of the display area or formed smaller than that. With regard to the minimum of the size of the piece, it is preferable that the size is large to some extent in relation to thickness of the piece in order that each edge of the piece shifted stepwise and the angle of the edges of the laminated pieces decrease gradually. It may be limited by the patterning process in the manufacturing, but it is preferable that the size may be several μm²-sizes square.

In the first embodiment, the colored layers are arranged so as to overlap each other slightly in a boundary area of colored layers. For example, in the third area, the piece of the B colored layer 23 and the piece of the R colored layer 22 are arranged so as to overlap each other slightly in their boundary area. The overlapping can prevent a gap from being formed between the colored layers.

The laminated-two-layers pieces of the second area and the one-layer pieces of the third area are arranged in one line respectively in their areas, but they can be arranged in other forms. For example, they can be arranged in several lines respectively in the second area and the third area. It is possible that the third area of the mosaic-shape one-layer structure is omitted and only the second area of the mosaic-shape laminated-two-layers structure is arranged outside of the first area.

Next, a method for manufacturing the liquid crystal display panel 10A according to the first exemplary embodiment of the present invention will be described in the following as shown in FIG. 5 to FIG. 7.

First, a method for manufacturing the color filter substrate 20A will be described. A resist including green pigment is applied over the glass substrate 26. A predetermined area in the display area 1, a predetermined area in the second area and a whole of the first area, that is, an area in which a green colored layer 21 is to be arranged is exposed with an exposure mask. Then, the resist developed and processed, and the G colored layer 21 is formed. The G colored layer 21 which has been formed is shown in FIG. 5.

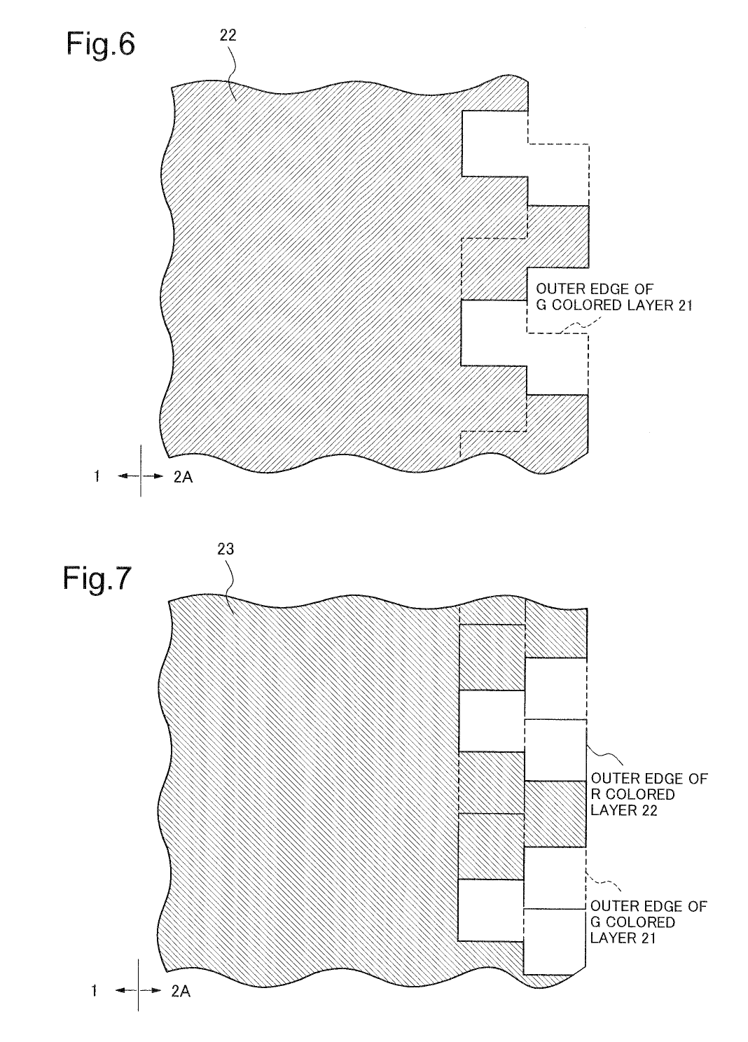

Next, a resist including red pigment is applied over the glass substrate 26 over which the G colored layer 21 has been formed. A part of an area on which the G colored layer 21 is not formed in the display area, a part of an area on which the G colored layer 21 is formed in the second area, a part of an area on which the G colored layer 21 is not formed in the second area and a whole of the first area, that is, an area in which a red colored layer 22 is to be arranged is exposed with an exposure mask. Then, the resist developed and processed, and the R colored layer 22 is formed. The R colored layer 22 which has been formed is shown in FIG. 6. Here, an outer edge of the G colored layer 21 is indicated by the broken line in FIG. 6.

Moreover, a resist including blue pigment is applied over the glass substrate 26 over which the G colored layer 21 and the R colored layer 22 have been formed. An area on which the first and second colored layers are not formed in the display area, an area on which the first and second colored layers are not overlapped in the second area and a whole of the first area, that is, an area in which a blue colored layer 23 is to be arranged is exposed with an exposure mask. Then, the resist developed and processed, and the B colored layer 23 is formed. The B colored layer 23 which has been formed is shown in FIG. 7. Here, an outer edge of the G colored layer 21 is indicated by a broken line and an outer edge of the R colored layer 22 is indicated by a dashed dotted line in FIG. 7.

Next, clear acrylic resin is applied and processed so as to cover the colored layers 21, 22 and 23, and an overcoat 24 is formed. Columnar spacers (not shown in Figures) made of acrylic resin are arranged on the overcoat 24, then, the color filter substrate 20A is manufactured.

Here, the columnar spacers may be arranged on the array substrate 30 instead of the color filter substrate 20A, and spherical spacers may be used instead of the columnar spacers. The colored layers 21, 22 and 23 are laminated in order of G, R and B, but the order of the colored layers is not limited to the above.

Moreover, thickness of colored layer is designed so that NTSC ratio on the chromaticity diagram becomes 40% while the image is displayed in the liquid crystal display panel 10A. NTSC ratio means an index for color display reproduction range. That is to say, the NTSC ratio shows the ratio of an area of a triangle which is formed by connecting chromaticity points of three primary colors such as R, G, and B to a display area in which a display apparatus can reproduce.

Specifically, each thickness of colored layers 21, 22 and 23 is set to about 1.0 μm. Transmission factor of the laminated-three-layers body composed of the colored layers 21, 22 and 23 is no more than 1%, so the body has enough light blocking effect and can replace the black matrix. Here, it is not necessary for the colored layers 21, 22 and 23 to have the same thickness. Thickness of the colored layers 21, 22 and 23 can be designed in consideration of display color reproductivity, white balance, adjustment of thickness of the liquid crystal 50 or the like according to purpose of the liquid crystal panel 10A.

Next, a method for manufacturing the array substrate 30 will be described. A common array substrate of active matrix type, which includes TFT using amorphous silicon as a switching element, is applied to the array substrate 30 of the first embodiment.

First, a first metal layer (opaque metal) is formed in shape of a predetermined pattern on a glass substrate for forming scanning wirings and common wirings. A gate insulation film and a thin film semiconductor layer are formed on the patterned first metal layer. The thin film semiconductor layer is formed in a shape of island on the area in which the switching elements will be made.

Next, a second metal layer is formed in a shape of a predetermined pattern thereon for forming image signal wirings and drain wirings. A contact layer for contacting the island shaped semiconductor layer is formed on the patterned second metal layer by etching.

Moreover, a passivation film is formed thereon. And through hole contacts which reach the drain wirings or common wirings are formed. Comb-shaped electrodes made of ITO (Indium Tin Oxide), that is, pixel electrodes and common electrodes are formed thereon including the through hole contacts. The pixel electrodes are connected with the drain wirings made of the second metal layer and the common electrodes are connected with the common wiring made of the first metal layer, then, the array substrate 30 is manufactured.

When the liquid crystal display panel 10A is manufactured with the color filter substrate 20A and the array substrate 30, an alignment film is formed over the color filter substrate 20A and over the array substrate 30 and a process for rubbing the alignment film in the predetermined direction is performed. Then, the seal 40 is formed on at least one substrate to join two substrates 20A and 30. Afterward, the liquid crystal 50 is poured from a predetermined inlet into space between the two substrates 20A and 30. The so-called IPS mode (In Plane Switching Mode) is formed. The IPS mode is a mode that the liquid crystal 50 is orientated homogeneously and driven by electric field which is generated between the pixel electrode and the common electrode.

In this state, polarizing plates are attached outside of the substrate 20A and 30 in the crossnicol state so as to make the liquid crystal 50 normally black. Furthermore, a backlight is arranged outside of the polarizing plate of the array substrate 30 and predetermined wirings are drawn. Then, the liquid crystal display panel 10A according to the first embodiment is manufactured.

By designing that the liquid crystal 50 of the normally black mode keeps an initial orientating state, the frame area 2A can be maintained as the light excluding area.

In the first embodiment, the IPS mode is applied to the liquid crystal display panel 10A, but other modes such as vertical alignment style can be applied thereto. The present invention can be applied to various image display apparatus such as an image display apparatus which controls a charged particle with electric field in place of the liquid crystal display panel 10A.

Further, it is the point of the first embodiment of the present invention that there are the laminated-three-layers structure (body), the mosaic-shape laminated-two-layers structure (pieces) and the mosaic-shape one-layer structure (pieces) in the frame area 2A. So, the shape, the structure, the manufacturing method or the like of other constituent are not limited to the above-mentioned description.

### A Second Exemplary Embodiment

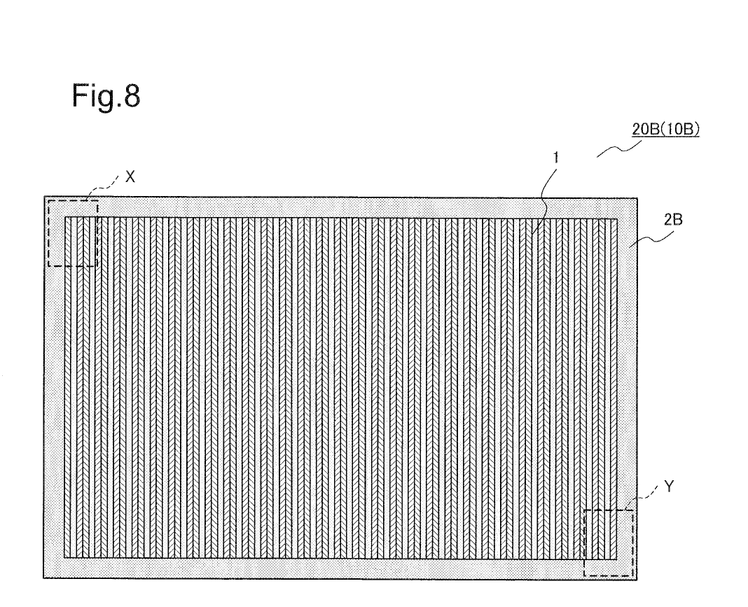

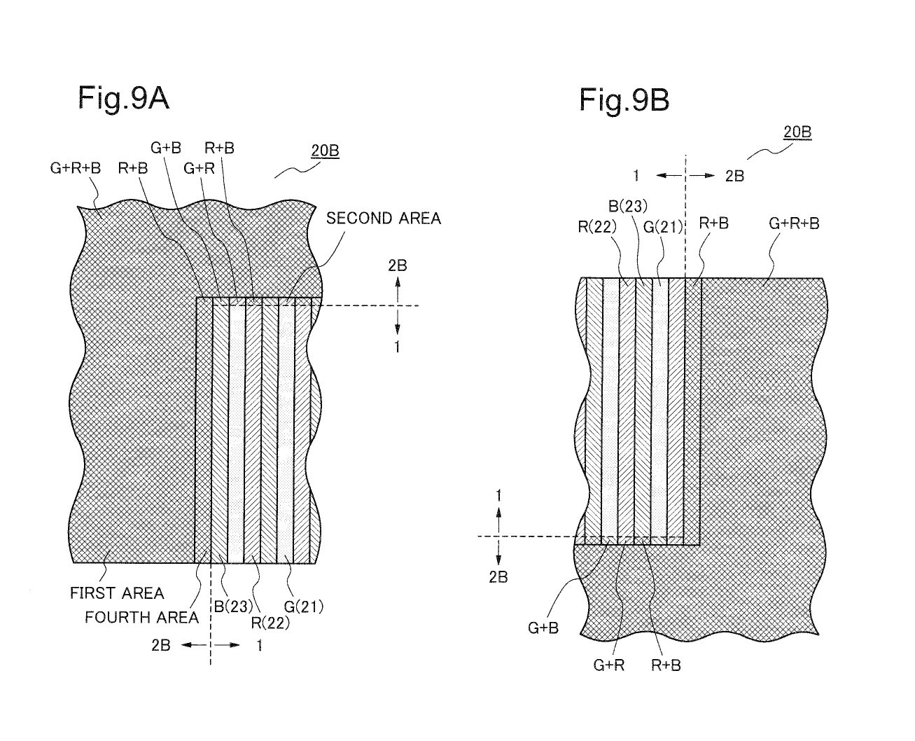

A color filter substrate and a liquid crystal display panel according to a second exemplary embodiment will be described in the following. FIG. 8 is a top view of a color filter substrate 20B of a liquid crystal display panel 10B according to the second embodiment. FIGS. 9A and 9B are partially enlarged views of an area X and an area Y shown in FIG. 8 respectively. FIG. 9A shows an upper left corner of a frame area 2B and a part of a display area 1. FIG. 9B shows a lower right corner of the frame area 2B and a part of the display area 1. Here, because it is easy to understand plan views of the rest of corners (bottom left and top right corners) in association with FIGS. 9A and 9B, description on the rest of corners is omitted.

In FIGS. 9A and 9B, in the display area 1 of the color filter substrate 20B, a G colored layer 21, a R colored layer 22 and a B colored layer 23 are arranged in shape of stripe.

Meanwhile, in a main area (a first area) which occupies most the frame area 2B of the color filter substrate 20B, the G colored layer 21, the R colored layer 22 and the B colored layer 23 are laminated and arranged, and the first area of the frame area 2B is formed by a laminated-three-layers body.

The second areas are formed adjacently to top and bottom portions of the display area 1 in the frame area 2B of the color filter substrate 20B. In the second areas, a plurality of three kinds of laminated pieces by laminating two pieces of the colored layers each having a different color are arranged in a shape of mosaic. That is, some laminated-two-layers pieces composed of a piece of the G colored layer 21 and a piece of the R colored layer 22, some laminated-two-layers pieces composed of a piece of the G colored layer 21 and a piece of the B colored layer 23, and some laminated-two-layers pieces composed of a piece of the R colored layer 22 and a piece of the B colored layer 23 are arranged in a shape of mosaic alternately. Then, the second area is formed in a mosaic-shape laminated-two-layers structure.

The fourth areas are formed adjacently to right and left edge portions of the display area 1 in the frame area 2B of the color filter substrate 20B. In the fourth areas, laminated pieces which are composed of at least two of the colored layers being the same shape as those of the display area 1 and each having a different color are arranged. That is, stripe-shape laminated-two-layers pieces which have two colored layers each having a different color are arranged in the fourth areas. In the second embodiment, the stripe-shape laminated-two-layers pieces composed of the R colored layer 22 and the B colored layer 23 are arranged on the fourth areas, and the fourth areas are formed in a stripe-shape laminated-two-layers structure. Since light blocking effect of the P colored layer 22 and the B colored layer 23 is high, the laminated pieces composed of the R colored layer 22 and the B colored layer 23 have high light blocking effect.

Here, an upper colored layer of the laminated pieces is continuously extended from the first area and has the same color as a colored layer which is adjacent to the lower colored layer in the display area 1. Therefore, it is possible to relax the dimensional accuracy of the colored layers, and it is possible to make it easy to manufacture the colored filter substrate 20B.

According to the above mentioned structure, the frame area 2B of the color filter substrate 20B includes the laminated-three-layers body of the first area, the laminated-two-layers pieces of the second area of the second area, and the stripe-shape laminated-two-layers pieces of the fourth areas. Moreover, the display area 1 includes the stripe-shape one-layer pieces. So number of colored layers for laminating decreases gradually toward the display area 1 and total thickness of the color filters decreases stepwise. Therefore, the liquid crystal 50 can be poured easily between the substrates and avoid the disorder of the orientation.

Moreover, since three kinds of the laminated pieces are arranged in shape of mosaic in the second area, the pieces can be made ineffective in coloring macroscopically mutually (achromatic). Accordingly, it is possible to avoid unnatural coloring, and it is possible consequently to provide the color filter substrate with high display quality.

According to the second embodiment, the stripe-shape laminated-two-layers pieces of the fourth area are composed of the R colored layer 22 and the B colored layer 23, but color of colored layer for composing the laminated pieces are not limited to red or blue and it is possible to change color of the laminated pieces appropriately.

According to the second embodiment, the second area is formed in the mosaic-shape laminated-two-layers structure and the fourth area is formed in the stripe-shape laminated-two-layers structure, but it is possible that one of the above mentioned structures is applied to either the second areas or the fourth areas or to both areas. Further, it is possible that the above-mentioned structure of inner side of the frame area 2B combines with the structure of outer side which is explained in the first embodiment.

It is the point of the second embodiment of the present invention that there are the laminated-three-layers structure (body), the mosaic-shape laminated-two-layers structure (pieces) and the stripe-shape laminated-two-layers structure (pieces) in the frame area 2B. So, the shape, the structure or the like of other constituent are not limited to the above-mentioned description.

### A Third Exemplary Embodiment

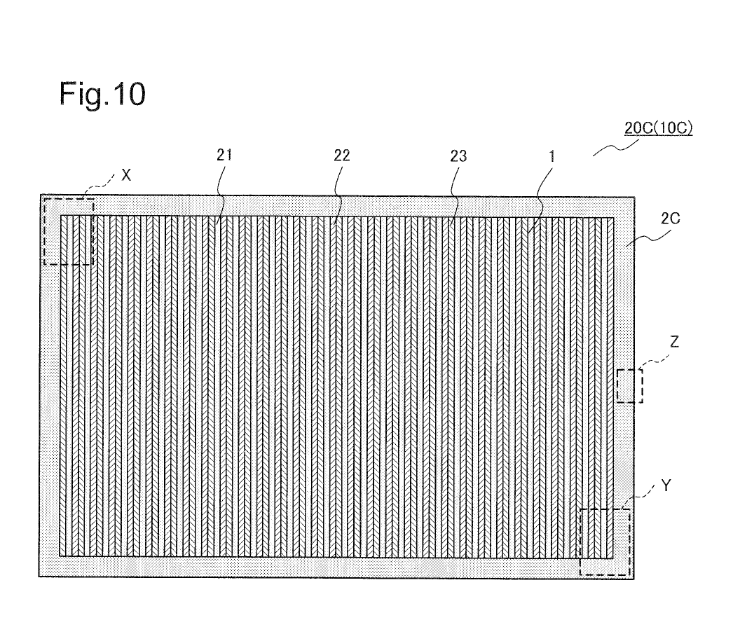

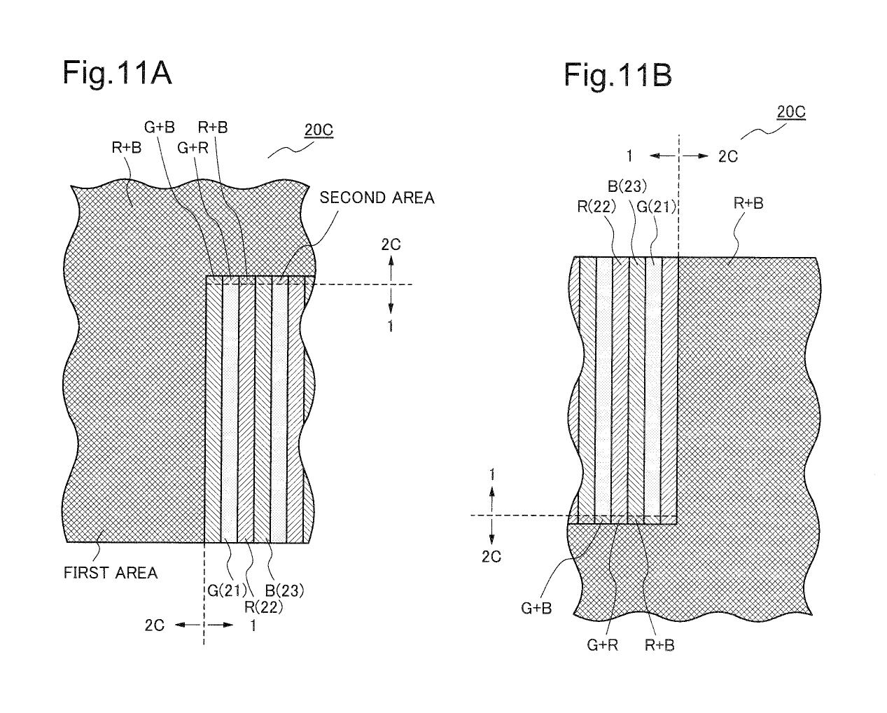

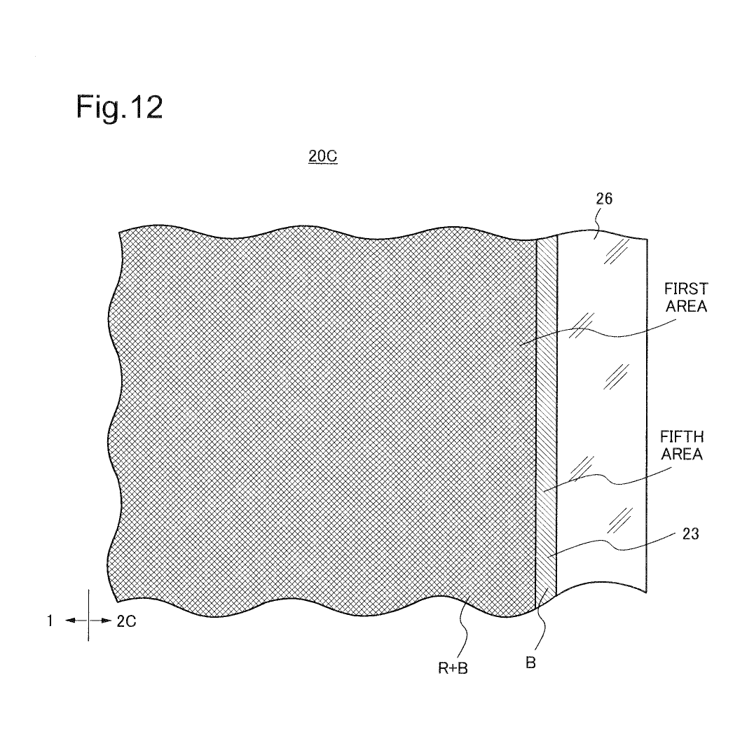

A color filter substrate and a liquid crystal display panel according to a third exemplary embodiment will be described in the following. FIG. 10 is a top view of a color filter substrate 20C according to the third embodiment. FIGS. 11A and 11B are partially enlarged views of an area X and an area Y shown in FIG. 10 respectively. FIG. 11A shows an upper left corner of a frame area 2C and a part of a display area 1. FIG. 11B shows a lower right corner of the frame area 2C and a part of the display area 1. FIG. 12 is a partially enlarged view of an area Z shown in FIG. 10.

In FIG. 10, the colored layers 21, 22 and 23 are arranged in shape of stripe in the display area 1 alternately, and the frame area 2C is arranged outside of the display area 1.

In the first and second embodiment, the main areas (the first areas) of the frame areas 2A and 2B are formed by the laminated-three-layers bodies including the G colored layer 21, the R colored layer 22 and the B colored layer 23. In the third embodiment, two colored layers of a R colored layer 22 and a B colored layer 23 are laminated and arranged in a main area (a first area) which occupies most the frame area 2C of the color filter substrate 20C. Then, the first area of the third embodiment is formed by a laminated-two-layers body.

As shown in FIGS. 11A and 11B, a second areas are formed adjacently to top and bottom portions of the display area 1 in the frame area 2C of the color filter substrate 20C. In the second areas, a plurality of three kinds of laminated pieces by Laminating two pieces of the colored layers each having a different color are arranged in a shape of mosaic. That is, some laminated-two-layers pieces composed of a piece of the G colored layer 21 and a piece of the R colored layer 22, some laminated-two-layers pieces composed of a piece of the G colored layer 21 and a piece of the B colored layer 23, and some laminated-two-layers pieces composed of a piece of the R colored layer 22 and a piece of the B colored layer 23 are arranged in a shape of mosaic alternately. Then, the second area of the third embodiment is formed in a mosaic-shape laminated-two-layers structure.

Moreover, as shown in FIG. 12, only the B colored layer 23 is arranged on a glass substrate 26 in a fifth area which is outside of the first area. Because one colored layer dose not have a high light blocking effect, it is preferable that the fifth area is formed thinly and arranged in an outermost area of the frame area 2C.

A light blocking effect of a laminated-two-layers body of the third embodiment is poorer than those of a laminated-three-layers body of the first and second embodiments, but the former is thinner than the latter. So, it is possible to pour liquid crystal 50 smoothly and avoid disorder of the liquid crystal 50. Above-mentioned structure may be applicable for an image display apparatus having thick colored layer which requires wide chromaticity range.

Next, a method for manufacturing the liquid crystal display panel 10C according to the third embodiment will be described in the following.

First, a method for manufacturing the color filter substrate 20C will be described. A resist including green pigment is applied over the glass substrate 26. An area in which a G colored layer 21 is to be arranged is exposed with an exposure mask. Here, the G colored layer 21 is not formed in the frame area 2C according to the third embodiment of the present invention. Then, the resist developed and processed, and the G colored layer 21 is formed.

Then, the R colored layer 22, the B layer 23 and an overcoat are formed on the glass substrate 26 of the color filter substrate 20C by the method similar to the first embodiment, columnar spacers are arranged on the overcoat, and the color filter substrate 20C is manufactured.

An array substrate is manufactured with the same method as one of the first embodiment of the present invention. After joining the array substrate and the color filter substrate 20C together, the liquid crystal is poured between two substrates. Furthermore, polarizing plates are joined outside of both substrates each, a backlight is arranged in the array substrate side and prescribed wirings are given. Then, the liquid crystal display panel 10C is manufactured.

Here, thickness of each colored layer of the color filter substrate 20C is designed so that NTSC ratio on the chromaticity diagram becomes 60% while the image is displayed in the liquid crystal display panel 10C. Specifically, each thickness of the colored layers 21, 22 and 23 is set to about 1.4 μm. In the first area of the frame area 2C, the laminated-two-layers body composed of the R colored layers 22 whose depth is about 1.4 μm and the B colored layer whose depth is about 1.4 μm is found to be colored in slight purple. But, transmission factor of the laminated-two-layers body is no more than 1%, so the body has enough light blocking effect and can replace the black matrix.

In the third embodiment, the laminated-two-layers body is composed of the R colored layer 22 and the B colored layer 23, but it may be composed of two colored layers including other colored layer. It may be possible for the above-mentioned fifth area not to be applied.

It is the point of the third embodiment of the present invention that there are the laminated-two-layers structure (body) and the mosaic-shape laminated-two-layers structure (pieces) in the frame area 2C. So, the shape, the structure, the manufacturing method or the like of other constituent are not limited to the above-mentioned description.

### A Fourth Exemplary Embodiment

A color filter substrate and a liquid crystal display panel according to a fourth exemplary embodiment will be described in the following. Though the frame area of the color filter substrate has the first area which is formed by the laminated-plural-layers body in the above-mentioned embodiments, a frame area of the fourth embodiment dose not have the first area but has an area including at least two kinds of laminated pieces.

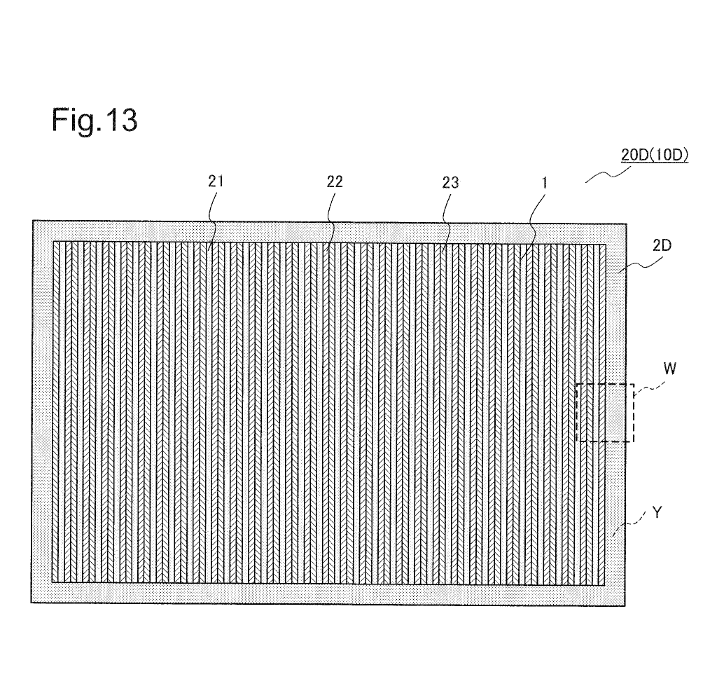

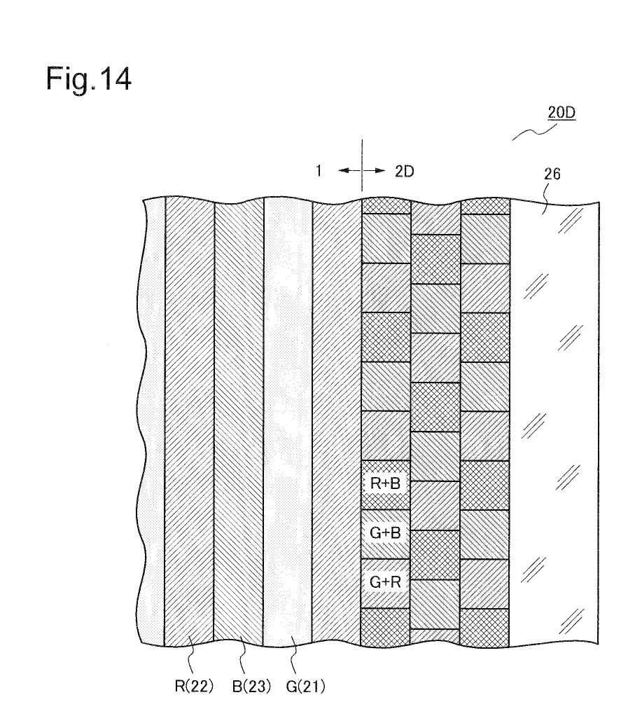

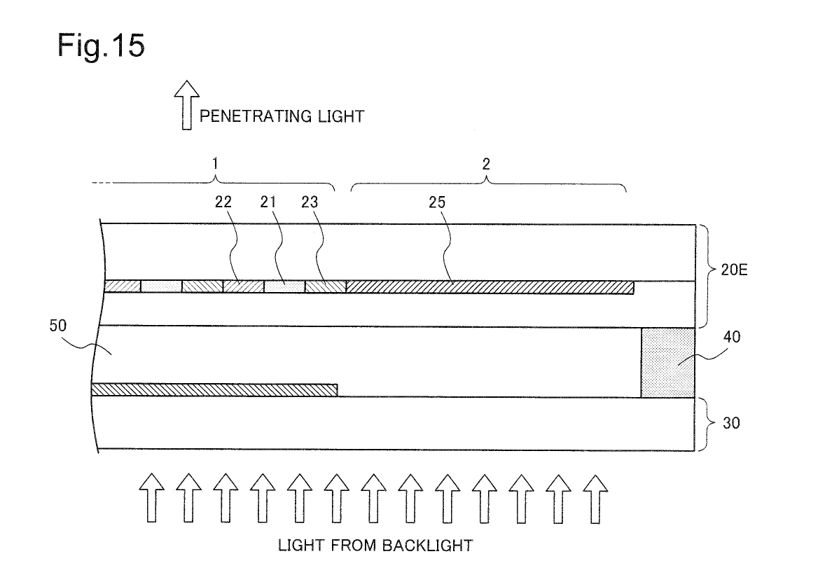

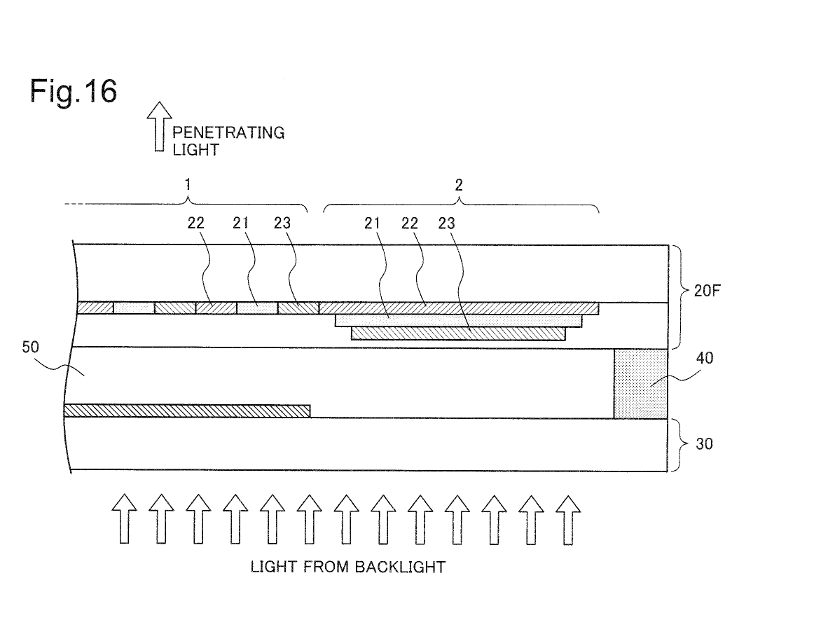

FIG. 13 is a top view of a color filter substrate 20D of a liquid crystal display panel 10D according to the fourth embodiment. FIG. 14 is a partially enlarged view of an area W shown in FIG. 13. As shown in FIG. 13, the colored layers 21, 22 and 23 are arranged in shape of stripe in the display area 1, and the frame area 2D is arranged outside of the display area 1. As shown in FIG. 14, in the frame area 2D of the color filter substrate 20D, a plurality of three kinds of laminated pieces by laminating two pieces of the colored layers each having a different color are arranged in three rows in a shape of mosaic. That is, some laminated pieces composed of a piece of the G colored layer 21 and a piece of the R colored layer 22, some laminated pieces composed of a piece of the G colored layer 21 and a piece of the B colored layer 23 and some laminated pieces composed of a piece of the R colored layer 22 and a piece of the B colored layer 23 are arranged in three rows in the shape of mosaic. Then, the frame area 2D is formed in a mosaic-shape laminated-two-layers structure.

According to the above-mentioned structure, the color filter substrate 20D includes the laminated-two-layers pieces in the frame area 2D. The laminated-two-layers piece has high light blocking effect, so it can replace the black matrix. Since three kinds of the laminated pieces are arranged in shape of mosaic of three rows in the frame area 2D, the pieces can be made ineffective in coloring macroscopically mutually (achromatic). Accordingly, it is possible to avoid unnatural coloring, and it is possible consequently to provide the color filter substrate with high display quality.

Furthermore, the laminated-two-layers piece on the frame area 2D of the fourth embodiment is thinner than the laminated-three-layers body on the frame areas 2A-2C. So, it is possible to pour liquid crystal 50 smoothly and avoid disorder of the liquid crystal 50.

It is the point of the fourth embodiment of the present invention that there is the mosaic-shape laminated-two-layers structure (pieces) in the frame area 2D. So, the shape, the structure or the like of other constituent are not limited to the above-mentioned description.

The color filter substrates 20A-20D of the above-mentioned exemplary embodiments of the present invention can include from the first area to the fifth area in the frame area 2A-2D appropriately. The laminated-plural-layers body and the laminated-plural-layers piece have high light blocking effect, so they can replace the black matrix.

There is the mosaic-shape laminated-two-layers piece in the second area which is outside or inside of the first area in the color filter substrate. Number of colored layers for laminating decreases gradually toward the peripheral end of the color filter substrate and total thickness of the color filters decreases stepwise. Accordingly, the liquid crystal 50 can be poured easily between the substrates and avoid the disorder of the orientation.

Moreover, since several kinds of pieces each having a different color are arranged in shape of mosaic in the second area and the third area, they can be made ineffective each other macroscopically in coloring (achromatic). Accordingly, it is possible to avoid unnatural coloring in the second and third areas, and it is possible to provide the color filter substrate with high display quality.

Further, each embodiment of the present invention adopts three colored layers of the RGB, but it is possible to adopt more than four colored layers or three primary colors other than RGB.

The liquid crystal display panels 10A-10D of the above-mentioned exemplary embodiments of the present invention can be applied to not only a liquid crystal display panel based on IPS type but also an active matrix liquid crystal display panel including color filters with a similar colored layer type in the light blocking layer. The liquid crystal display panels 10A-10D can be utilized for a monitor of computer, an LCD television set, a cellular phone, a GPS terminal, a car navigation system, a game machine, a terminal in bank and convenience store and a medical diagnostic apparatus or the like which include a liquid crystal display panel.

The color filter substrates 20A-20C according to the above mentioned exemplary embodiments include a first area in the frame area 2A-2C, a second area in which the laminated pieces are arranged in a shape of mosaic and which is adjacent to the first area in the frame area 2A-2C and a laminated body being composed by laminating at least two colored layers each including a different color and being arranged in the first area.

The color filter substrate 20A according to the above mentioned exemplary embodiment includes a third area being adjacent to the second area in the frame area 2A and at least two kinds of pieces of colored layer each including a different color and being arranged in the third area in a shape of mosaic.

The color filter substrate 20B according to the above mentioned exemplary embodiment includes stripe colored layers being arranged in the display area 1 alternately and each including a different color, a fourth area being adjacent to a side of the stripe colored layer of the display area 1 in the frame area 2B and laminated pieces which are composed by laminating at least two colored layers being the same shape as the stripe colored layer of the display area 1 and each including a different color and which are arranged in the fourth area.

The color filter substrate 20C according to the above mentioned exemplary embodiment includes a fifth area being outermost area of the frame area 2C. Here, one of the colored layers is arranged in the fifth area.

In the color filter substrates 20A-20D according to the above mentioned exemplary embodiments, the colored layers include a green colored layer 21, a red colored layer 22 and a blue colored layer 23.

In the liquid crystal display panels 10A-10C according to the above mentioned exemplary embodiments, the color filter substrates 20A-20C further include a first area in the frame area 2A-2C, a second area in which the laminated pieces are arranged in a shape of mosaic and which is adjacent to the first area in the frame area 2A-2C, and a laminated body being composed by laminating at least two colored layers each including a different color and being arranged in the first area.

In the liquid crystal display panels 10A-10D according to the above mentioned exemplary embodiments, the colored layers include a green colored layer 21, a red colored layer 22 and a blue colored layer 23.

In the method for manufacturing the color filter substrates 20A-20C according to the above mentioned exemplary embodiments, the first colored layer is a green colored layer 21, the second colored layer is a red colored layer 22, and the third colored layer is a blue colored layer 23.

In the method for manufacturing the color filter substrates 20A-20C according to the above mentioned exemplary embodiments, laminating and arranging the first colored layer, the second colored layer and the third colored layer on an area in which is adjacent to a part of the laminated pieces in the frame area 2A-2C

In the method for manufacturing the color filter substrates 20A-20D according to the above mentioned exemplary embodiments, the first colored layer is a green colored layer 21, the second colored layer is a red colored layer 22, and the third colored layer is a blue colored layer 23.

When the liquid crystal display apparatus which is disclosed in the related art 1 and the related art 4 in the background art is applied to a liquid crystal display apparatus including colored layers in stead of a black matrix, the following problems occur. That is, in the liquid crystal display apparatus of the related art 1 and the related art 4, there is one colored layer or two colored layers is arranged in shape of sheet in an area in which number of colored layers for laminating decrease, and the area is formed in a sheet-shape one-layer structure or a sheet-shape laminated-two-layers structure. A sheet-shape one-layer body includes only one colored layer, so it does not have enough light blocking effect. When a sheet-shape laminated-two-layers body is arranged, a balance of hue collapses. Then, the area having the sheet-shape laminated-two-layers body is colored unnaturally. Accordingly, display quality becomes degraded remarkably.

Moreover, when the liquid crystal display apparatus which is disclosed in the related art 5 is applied to a liquid crystal display apparatus including a colored layer in stead of a black matrix, it cannot acquire an enough light blocking effect because that an area which is composed of only one blue colored layer occupies ⅓ of its whole frame area.

On the other hand, when the color filter substrate and the liquid crystal display panel according to the present invention is applied to a liquid crystal display apparatus including colored layers in stead of a black matrix, foil owing advantageous effects are obtained. That is, the laminated-plural-layers body and the laminated-plural-layers piece have a high light blocking effect, so they can replace the black matrix enough. Since several kinds of the pieces are arranged in shape of mosaic alternately in the area in which number of the colored layers for laminating decrease, the pieces can be made ineffective mutually in coloring macroscopically. Accordingly, it is possible to avoid unnatural coloring, and it is possible consequently to provide the color filter substrate and the liquid crystal display panel with high display quality.

Moreover, in the frame area of the color filter substrate of the present invention, number of colored layers for laminating decreases gradually toward the peripheral end of the color filter substrate and total thickness of the color filters decreases stepwise, so the liquid crystal can be poured easily between the substrates and avoid the disorder of the orientation.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

What is claimed is:

1. A color filter substrate, comprising:
a display area for displaying images;
a frame area being adjacent to said display area; and
at least two kinds of laminated pieces which are composed by laminating at least two pieces of colored layers each including a different color;
wherein said laminated pieces are arranged in said frame area in a shape of mosaic.

2. A color filter substrate according to claim 1, further comprising:
a first area in said frame area;
a second area in which said laminated pieces are arranged in a shape of mosaic and which is adjacent to said first area in said frame area; and
a laminated body being composed by laminating at least two colored layers each including a different color and being arranged in said first area.

3. A color filter substrate according to claim 2, further comprising:
a third area being adjacent to said second area in said frame area; and
at least two kinds of pieces of colored layer each including a different color and being arranged in said third area in a shape of mosaic.

4. A color filter substrate according to claim 2, further comprising:
stripe colored layers being arranged in said display area alternately and each including a different color;
a fourth area being adjacent to a side of said stripe colored layer of said display area in said frame area; and
laminated pieces which are composed by laminating at least two colored layers being the same shape as said stripe colored layer of said display area and each including a different color and which are arranged in said fourth area.

5. A color filter substrate according to claim 2, further comprising:
a fifth area being outermost area of said frame area; and
wherein one of said colored layers is arranged in said fifth area.

6. A color filter substrate according to claim 1:
wherein said colored layers include a green colored layer, a red colored layer and a blue colored layer.

7. A liquid crystal display panel in which liquid crystal is enclosed between an array substrate and a color filter substrate,
wherein said color filter substrate includes a display area for displaying images, a frame area being adjacent to said display area and at least two kinds of laminated pieces which are composed by laminating at least two pieces of colored layers each including a different color; and
wherein said laminated pieces are arranged in said frame area in a shape of mosaic.

8. A liquid crystal display panel according to claim 7,
wherein said color filter substrate further includes a first area in said frame area, a second area in which said laminated pieces are arranged in a shape of mosaic and which is adjacent to said first area in said frame area, and a laminated body being composed by laminating at least two colored layers each including a different color and being arranged in said first area.

9. A liquid crystal display panel according to claim 8,
wherein said colored layers include a green colored layer, a red colored layer and a blue colored layer.

10. A method for manufacturing a color filter substrate including a display area for displaying images and a frame area being adjacent to said display area, comprising:
forming a first colored layer on predetermined areas in said display area and said frame area;
forming a second colored layer on a part of an area on which said first colored layer is not formed in said display area, a part of an area on which said first colored layer is not formed in said frame area and a part of an area on which said first colored layer is not formed in said frame area; and
forming a third colored layer on an area on which said first and second colored layers are not formed in said display area and an area on which said first and second colored layers are not overlapped in said frame area.

11. A method for manufacturing a color filter substrate including a display area for displaying images and a frame area being adjacent to said display area, in case that said frame area being adjacent to said display area includes a first area and a second area being adjacent to said first area, comprising:
forming a first colored layer on a predetermined area in said display area, a predetermined area in said second area and a whole of said first area;
forming a second colored layer on a part of an area on which said first colored layer is not formed in said display area, a part of an area on which said first colored layer is not formed in said second area, a part of an area on which said first colored layer is not formed in said second area and a whole of said first area; and
forming a third colored layer on an area on which said first and second colored layers are not formed in said display area, an area on which said first and second colored layers are not overlapped in said second area and a whole of said first area.

12. A method for manufacturing said color filter substrate according to claim 10,
wherein said first colored layer is a green colored layer,
wherein said second colored layer is a red colored layer, and
wherein said third colored layer is a blue colored layer.

13. A method for manufacturing a color filter substrate including a display area and a frame area adjacent to said display area, comprising:
arranging a first colored layer, a second colored layer and a third colored layer in said display area alternately; and
arranging three kinds of laminated pieces composed by laminating two pieces out of a piece of a first colored layer, a piece of a second colored layer and a piece of a third colored layer in said frame area in a shape of mosaic.

14. A method for manufacturing said color filter substrate according to claim 13,
laminating and arranging said first colored layer, said second colored layer and said third colored layer on an area in which is adjacent to a part of said laminated pieces in said frame area.

15. A method for manufacturing said color filter substrate according to claim 13,
wherein said first colored layer is a green colored layer,
wherein said second colored layer is a red colored layer, and
wherein said third colored layer is a blue colored layer.
